(19) United States
(12) Patent Application Publication
(10) Pub. No.: US 2005/0076795 A1
(43) Pub. Date: Apr. 14, 2005

(54) Chafing dish support structure, chafing dish serving station and heating burner subassembly

(76) Inventor: Guy Riddle, Santa Monica, CA (US)

Correspondence Address: Daniel J. Meaney, Jr., Post Office Box 22307, Santa Barbara, CA, 93121, US

(21) Appl. No.: 10/683,751

(22) Filed: Oct. 9, 2003

(51) Int. Cl. A23C 3/02

(52) U.S. Cl. 99/483

(57) ABSTRACT

A chafing dish support structure is shown. The chafing dish support structure comprises a pair of spaced, elongated sidewall defining members having a selected longitudinal dimension and a selected lateral dimension configured for forming a chafing dish receiving section for supporting at least one of a chafing dish and warming pan above a heating burner placed below the chafing dish receiving section. Each of the sidewall-defining members having opposed end structural members defining lifting members. A pair of spaced, elongated support members defining horizontal and vertically extending support members are operatively connected to each of the sidewall defining members at predetermined locations for supporting the chafing dish receiving section above a heating burner placed below the chafing dish receiving section. A chafing dish serving station having a decorative shell structure is also shown.

### CROSS-REFERENCES TO RELATED APPLICATIONS

Not Applicable

### STATEMENT REGARDING FEDERALLY SPONSORED RESEARCH OR DEVELOPMENT

Not Applicable

### REFERENCE TO A “MICROFICHE APPENDIX” (SEE 37 CFR 1.96)

Not Applicable

### BACKGROUND OF THE INVENTION

1. Field of the Invention

The present invention relates to a chafing dish support structure, chafing dish serving station and a heating burner subassembly for use with the chafing dish support structure and chafing dish serving station, generally, and more specifically, relates to a chafing dish support structure having a pair of spaced, co-planar elongated sidewall defining members having a selected width, each of the sidewall defining members having a selected longitudinal length and a selected lateral length configured for forming a chafing dish receiving section for supporting at least one of a chafing dish and boiler-type warming pan above a heating burner placed below the chafing dish receiving section and a pair of spaced, elongated support members defining horizontal and vertically extending support members operatively connected to each of the sidewall defining members at predetermined locations for supporting the chafing dish receiving section above a heating burner placed below a chafing dish receiving section.

In addition, this invention relates to a chafing dish serving station having a chafing dish support structure and a decorative shell structure dimensioned so as to enclose the chafing dish support structure and heating burner and wherein the decorative shell structure is fabricated from a material which is fire resistant so as enclose a heating burner and wherein the decorative shell structure has an outer wall positioned away from the chafing dish support structure to define a viewing surface having an exterior outer surface fabricated with a material depicting an ornamental appearance.

In addition, this invention relates to a combination of a chafing dish support structure and chafing dish serving station wherein decorative shell rigid exterior wall members including a viewing surface having an exterior outer surface fabricated with a material depicting an ornamental appearance forming a chafing dish serving station having an appearance defined by the viewing surface ornamental appearance.

2. Description of the Prior Art

Chafing dishes including chafing dish support structures are well known in the prior art.

Typically, a chafing dish support structure of the prior art comprises at least one sidewall defining member having a selected longitudinal dimension and a selected lateral dimension configured for forming a chafing dish receiving section for supporting at least one of a chafing dish and a double boiler type warming pan above a heating burner placed below the chafing dish receiving section. The sidewall-defining members include handles as lifting members. FIG. 22, labeled prior art and discussed below, is typical of such prior art chafing dish support structures.

Other examples of known prior art chafing dish support structures are: (i) a rectangular shaped chafing dish support structure disclosed in Chafing Dish of Stainless Steel, Two Pages, REALCOOK.COM, 2001; (ii) a rectangular shaped chafing dish support structure disclosed in Rectangular Chafing Dish. One Page, SS Exports, 2003; (iii) a rectangular shaped chafing dish support structure in the form of a wrought iron stand is disclosed in Stainless Steel Oblong Chafing Dish w/wrought Iron Stand, steelware for the best dressed tables, One Page, image/imports.com, 2003; and (iv) a rectangular shaped chafing dish support structure and a circular shape chafing dish structure disclosed in Stainless Steel Chafing Dish and Food Warmer-Cookware, One Page, Reviews, Rating, 2003.

Wire stand chafing dish support structures are disclosed in U.S. Pat. Nos. 6,047,932; 5,996,948 and 5,921,513. The wire stand chafing dish support structures in U.S. Pat. Nos. 6,047,932; 5,996,948 and 5,921,513 have a chafing dish receiving section and a heating burner support section, all formed as an integral unit.

U.S. Pat. No. D468,580 discloses a chafing dish-like device in the form of an integral unit having a chafing dish, chafing dish support structure and heating burner support structure.

U.S. Pat. No. 4,899,722 discloses burner assembly for heating chafing dishes wherein the chafing dish support structure is generally in the form of the prior art chafing dish support structure shown in FIG. 22 labeled prior art.

Integral chafing dish support structures may be fabricated in numerous forms and shapes. Examples include a rectangular chafing dish disclosed in Des 434,268 and an oval chafing dish is disclosed Des 434,594.

Folding holders for holding or enclosing chafing dish support structures are known in the prior art. Folding holders for a chafing dish having openings formed in sidewalls and opening formed in end walls are disclosed in U.S. Pat. Nos. 5,517,903 and Des 305,972. A collapsible and nestable chafing dish holder having a fabric skirt for supporting standard water pans for warming food, food pans and lids are disclosed in E-Z Buff chafing dish, Three Pages, E-Z Buff, 2003.

A windshield for a chafing dish burner having a vertical height that is sufficient to encloses the burners only and configured to be located under the chafing dish support structure and chafing dish is disclosed in U.S. Pat. No. 4,838,446.

An entertainment table in the form of a cabinet for dispensing and serving hot and cold foods having a plurality of compartments within the cabinet is disclosed in U.S. Pat. No. 3,997,028.

Heating burner assemblies using alcohol burners and Sterno brand fuel canisters for heating or warming food in a chafing dish are well known in the art. Several of the prior art references discussed above include a burner assembly support member for positioning a heating burner below a chafing dish. Variable-heat chafing-dish burners and methods for using the same are disclosed in U.S. Pat. No. 6,135,759. Another example of a burner assembly for heating chafing dishes is shown in U.S. Pat. No. 4,889,722.

The disclosure of all of the above prior art references and Patents referred into this specification are hereby incorporated by reference as if set forth verbatim herein.

The prior art chafing dish support structures tend to have a single, large sidewall defining member having a selected longitudinal length and a selected lateral width configured for forming a chafing dish receiving section for supporting a chafing dish or a double boiler type warming pan above a heating burner placed below the chafing dish. Such structures make handling, transporting, setting up, tearing down, cleaning and sanitizing of the structure difficult. Further, the heating burner or burners may, during use, have the flames exposed to wind, e.g., a gust of wind, a continuous wind or other windy conditions, collectively, “wind”. As such, the flames of the burners can be extinguished by the wind and that is undesirable.

A chafing dish support structure having at least one of a double boiler type warming pan and chafing dish, a chafing dish cover and a heating burner are typically supported at a desired serving level, e.g. on a table top or counter top, to facilitate dispensing and serving of prepared, warmed food. In such serving situations, the ornamental appearance of a chafing dish support structure, double boiler type warming pan, chafing dish, chafing dish cover and heating burner are enhanced using foldable support devices.

Further, the heating burners of the prior art are typically inserted or slid onto a fixed heating burner support device located below the chafing dish receiving section and such heating burner can be subject to displacement, sliding or being tipped over if the chafing dish support structure is bumped, hit or otherwise moved when the heating burner is in place and ignited, which is both undesirable and unsafe.

None of the prior art anticipate, disclose, suggest or teach a chafing dish support structure comprising a pair of spaced, co-planar elongated sidewall defining members having a selected longitudinal length and a selected lateral width configured for forming a chafing dish receiving section for supporting at least one of a chafing dish and/or warming pan above a heating burner placed below the chafing dish receiving section and wherein each of the sidewall defining members have opposed, shaped, planar end structural members defining lifting members; and a pair of spaced, elongated co-planar support members defining horizontal and vertically extending support members operatively connected to each of the sidewall defining members at predetermined locations for supporting the chafing dish receiving section above a heating burner placed below at least one of a chafing dish and warming pan positioned in the chafing dish receiving section.

Further, none of the prior art anticipate, disclose, suggest or teach a chafing dish serving station comprising a chafing dish supporting structure having a selected longitudinal length and a selected lateral width configured for forming a chafing dish receiving section for supporting at least one of a chafing dish and warming pan above a heating burner placed below the chafing dish receiving section and a decorative shell structure having spaced opposed outer walls having a vertical height substantially equal to the vertical height of the chafing dish support structure so as to enclose the chafing dish structure and heating burner. The decorative shell structure is fabricated from a material which is fire resistant so as enclose a heating burner and has one of its spaced opposed outer walls positioned away from the chafing dish support structure to define a viewing surface having an exterior outer surface fabricated with a material depicting an ornamental appearance exposing the viewing surface to form a chafing dish serving station having an appearance defined by the viewing surface ornamental appearance.

Still further, none of the prior art anticipate, disclose, suggest or teach a combination of a chafing dish support structure, including both a chafing dish support structure disclosed herein or as known in the prior art, and a chafing dish serving station defining a viewing surface having an exterior outer surface fabricated with a material depicting an ornamental appearance exposing the viewing surface to form a chafing dish serving station having an appearance defined by the viewing surface ornamental appearance.

### BRIEF SUMMARY OF THE INVENTION

The present invention seeks to overcome the problems of the prior art by providing a new, novel and unique chafing dish support structure, chafing dish serving station and heating burner subassembly.

In the preferred embodiment, the chafing dish support structure comprises a pair of spaced, co-planar elongated sidewall defining members having a selected longitudinal length and a selected lateral width and are configured for forming a chafing dish receiving section for supporting at least one of a chafing dish and warming pan above a heating burner placed below the chafing dish receiving section. Each of the sidewall-defining members has opposed, shaped, end structural members defining lifting members. A pair of spaced, elongated co-planar support members defining horizontal and vertically extending support members are operatively connected to each of the sidewall defining members at predetermined locations for supporting the chafing dish receiving section above a heating burner placed below at least one of a chafing dish and warming pan positioned in the chafing dish receiving section.

A chafing dish serving station for enclosing a chafing dish supporting structure having a selected longitudinal length and a selected lateral width configured for forming a chafing dish receiving section for supporting at least one of a chafing dish and warming pan above a heating burner placed below the chafing dish is disclosed and taught by the present invention. The chafing dish support structure has a selected vertical height and a selected lineal outer dimension that entirely circumscribes the selected longitudinal length and selected lateral width.

The chafing dish support structure may comprise the chafing dish support structure disclosed herein or can be used in combination with the prior art chafing dish support structures. The chafing dish serving station includes a decorative shell structure having spaced opposed outer walls having a vertical height substantially equal to the vertical height of the chafing dish support structure, as a selected vertical height, and a lineal dimension substantially equal to the lineal outer dimension of the chafing dish support structure, as a selected lineal outer dimension, so as to enclose the chafing dish structure and heating burner. The decorative shell structure may be fabricated from a material that is fire resistant so as enclose a heating burner.

The decorative shell structure has one of its spaced opposed outer walls positioned away from the chafing dish support structure to define a viewing surface having an exterior outer surface fabricated with a material depicting an ornamental appearance. The decorative shell structure is configured to be removeably attached to the chafing dish support structure exposing the viewing surface forming a chafing dish serving station having an appearance defined by the viewing surface ornamental appearance.

Therefore, it is an advantage of the present invention to provide a chafing dish support structure that is easy to handle, transport, clean and sanitize.

One advantage of the present invention is that a chafing dish support structure, both in the form of the preferred embodiment disclosed herein and as known in the prior art, can be used in combination with a decorative shell structure having spaced opposed outer walls having a vertical height substantially equal to the vertical height and a lineal dimension of the chafing dish support structure so as to enclose the chafing dish support structure and heating burner.

Another advantage of the present invention is that the decorative shell may be fabricated from a material that is fire resistant so as enclose a heating burner.

Another advantage of the present invention is that the decorative shell may be fabricated from a material that is fire resistant so as enclose a heating burner subassembly.

Another advantage of the present invention is that the decorative shell structure has one of its spaced opposed outer walls positioned away from the chafing dish support structure to define a viewing surface having an exterior outer surface fabricated with a material depicting an ornamental appearance.

Another advantage of the present invention is that the decorative shell structure can be configured to be removeably attached to the chafing dish support structure exposing the viewing surface forming a chafing dish serving station having an appearance defined by the viewing surface ornamental appearance.

Another advantage of the present invention is that a heating burner subassembly can be used in combination with the chafing dish support structure to securely slidably position one, two or three heating fuel containers burners at selected locations under a chafing dish positioned in a chafing dish receiving section of the chafing dish support structure.

Another advantage of the present invention is that a heating burner subassembly removeably support one, two or three heating fuel containers in a secure heating burner clamping section to resist displacement, moving, sliding or tipping over of one or more heating fuel containers if the chafing dish support structure is bumped, hit or otherwise moved when the heating burner is in place and ignited thereby improving the safety associated with using chafing dish support structure, alone, or in combination with a decorative shell structure forming a chafing dish serving station.

### BRIEF DESCRIPTION OF THE DRAWING

The present invention will become more fully understood from the following detailed description of a preferred, but non-limiting embodiment thereof, described in connection with the accompanying drawings, wherein:

FIG. 1 is a top, front and left side perspective view of a chafing dish support structure wherein a heating burner sub-assembly, shown in phantom, is located below a chafing dish support section;

FIG. 2 is a bottom, rear and right side perspective view of the chafing dish support structure of FIG. 1;

FIG. 3 is a top plan view of the chafing dish support structure of FIG. 1;

FIG. 4 is a right side elevational view of the chafing dish support structure of FIG. 3;

FIG. 5 is a left side elevational view of the chafing dish support structure of FIG. 3;

FIG. 6 is a rear elevational view of the chafing dish support structure of FIG. 3;

FIG. 7 is a front elevational view of the chafing dish support structure of FIG. 3;

FIG. 8 is a top, front and left side perspective view of a chafing dish serving station having, shown in phantom, a chafing dish support structure, a heating burner sub-assembly, a chafing dish and warming pan enclosed therein and chafing dish cover;

FIG. 9 is a bottom, rear and right side perspective view of the chafing dish serving station of FIG. 8;

FIG. 10 is a top plan view of the chafing dish serving station of FIG. 8;

FIG. 11 is a right side elevational view of the chafing dish serving station of FIG. 10;

FIG. 12 is a left side elevational view of the chafing dish serving station of FIG. 10;

FIG. 13 is a rear elevational view of the chafing dish serving station of FIG. 10;

FIG. 14 is a front elevational view of the chafing dish serving station of FIG. 10;

FIG. 15 is a top, front and left side perspective view of a combination of a chafing dish support structure and a chafing dish serving station having, shown in phantom, a heating burner subassembly, chafing dish and/or warming pan enclosed therein and chafing dish cover;

FIG. 16 is a bottom, rear and right side perspective view of the combination of a chafing dish support structure and a chafing dish serving station of FIG. 15;

FIG. 17 is a top plan view of the combination of a chafing dish support structure and a chafing dish serving station of FIG. 15;

FIG. 18 is a right side elevational view of the combination of a chafing dish support structure and a chafing dish serving station of FIG. 15;

FIG. 19 is a left side elevational view of the combination of a chafing dish support structure and a chafing dish serving station of FIG. 15;

FIG. 20 is a rear elevational view of the combination of a chafing dish support structure and a chafing dish serving station of FIG. 15;

FIG. 21 is a front elevational view of the combination of a chafing dish support structure and a chafing dish serving station of FIG. 15.

FIG. 22 is front, top and left side perspective view of a prior art chafing dish support structure having at least one sidewall defining member having a selected longitudinal length and a selected lateral length configured for forming a chafing dish receiving section for supporting at least one of a chafing dish and warming pan above a heating burner placed below the chafing dish;

FIG. 23 is a front elevational view of the chafing dish support structure of FIG. 22 in combination with a decorative shell structure shown in dashed lines and configured to be removeably attached to the chafing dish support structure exposing the viewing surface forming a chafing dish serving station having an appearance defined by the viewing surface ornamental appearance;

FIG. 24 is a right side elevational view of the chafing dish serving station of FIG. 23;

FIG. 25 is front, top and left side perspective view of a chafing dish support structure shown in FIG. 1 having a heating burner subassembly, located below the chafing dish receiving section, having a fixed base support member and an insertable and removable slidable support member having heating burner clamping sections configured for removeably holding heating burner fuel containers in position thereon with the insertable and removable sliceable support member shown in an extended loading position;

FIG. 26 is an exploded pictorial representation of an insertable and removable member having heating burner-clamping sections configured for removeably holding heating burner fuel containers in position thereon;

FIG. 27 is an exploded pictorial representation of a decorative shell rigid exterior wall members having spaced opposed outer walls having a vertical height substantially equal to the vertical height of a chafing dish support structure and configured as a sidewall to form a chafing dish serving station;

FIG. 28 is an exploded pictorial representation of a decorative shell rigid exterior wall members having spaced opposed outer walls having a vertical height substantially equal to the vertical height of a chafing dish support structure and configured as an end wall to form a chafing dish serving station;

FIG. 29 is an exploded pictorial representation of a combination of a chafing dish support structure of FIG. 1, two pair of decorative shell rigid exterior wall members having spaced opposed outer walls having a vertical height substantially equal to the vertical height of a chafing dish support structure and configured to form a chafing dish serving station and a heating burner subassembly;

FIG. 30A is an end elevational view pictorial representation partly in cross-section showing an end structural member defining a lifting members in the form of a shaped, planar structural member having an outwardly extending top member defining a lifting lip and a thermally insulated lifting member having a hollowed out central area configured to removeably slide onto and enclose the lifting lip;

FIG. 30B is an top planar view pictorial representation partly of the outwardly extending top member defining a lifting lip and a thermally insulated lifting member illustrated in FIG. 30A;

FIG. 31 is a end elevational view pictorial representation of a decorative shell rigid exterior wall member having spaced opposed outer walls and a viewing surface having an exterior outer surface fabricated with a material depicting an ornamental appearance configured to be removeably attached to a chafing dish support structure by an attachment member in the form of an elongated groove to form a chafing dish serving station having an appearance defined by said viewing surface ornamental appearance;

FIG. 32A is a pictorial representation of a section of a decorative shell rigid exterior wall member having spaced opposed outer walls and a viewing surface having an exterior outer surface fabricated with a material depicting an ornamental appearance configured to be removeably attached to a chafing dish support structure by an attachment member in the form of an aperture for supportingly engaging a hook-like member located on a chafing dish support structure for removeably attaching the decorative shell rigid outer member to a hook-like member to form a chafing dish serving station having an appearance defined by said viewing surface ornamental appearance;

FIG. 32B is an end elevational pictorial representation of a combination of a decorative shell rigid exterior wall member having an aperture of FIG. 32A and a hook-like member located on a chafing dish support structure for removeably attaching the decorative shell rigid outer member to a hook-like member to form a chafing dish serving station having an appearance defined by said viewing surface ornamental appearance;

FIG. 33A is a pictorial representation of a section of a decorative shell rigid exterior wall member having spaced opposed outer walls and a viewing surface having an exterior outer surface fabricated with a material depicting an ornamental appearance configured to be removeably attached to a chafing dish support structure by an attachment member in the form of female fastening member for supportingly engaging a conical-shaped male fastening member located on a chafing dish support structure for removeably attaching the decorative shell rigid outer member to a chafing dish support structure to form a chafing dish serving station having an appearance defined by said viewing surface ornamental appearance;

FIG. 33B is an end elevational pictorial representation of a combination of a decorative shell rigid exterior wall member having a female fastening member of FIG. 32A and a male fastening member located on a chafing dish support structure for removeably attaching the decorative shell rigid outer member to a chafing dish support structure to form a chafing dish serving station having an appearance defined by said viewing surface ornamental appearance;

FIG. 34 is a pictorial representation of a chafing dish support structure having a geometrical shape that is a generally rectangular shape;

FIG. 35 is a pictorial representation of a chafing dish support structure having a geometrical shape that is a generally oval shape; and

FIG. 35 is a pictorial representation of a chafing dish support structure having a geometrical shape that is a generally circular shape.

### DETAILED DESCRIPTION OF THE INVENTION

### Background

In the food catering and food servicing business, heated prepared foods are typically dispensed and served in a self-serve or buffet type arrangement. One or more chafing dish assemblies are generally used to position the food at tabletop level for ease and convenience of service to a person using the food services.

The chafing dish assemblies usually comprise a chafing dish support structure for holding a double-boiler type pan, referred to herein as a “warming pan” and for positioning one or more heating burners, as a heating or warming source, under the double boiler pan. The double-boiler pan/warming pan is generally filled with water and a serving dish or chafing dish is nestled within the double-warming pan. A chafing dish cover or lid may be used to cover the serving dish or chafing dish. Heat for a heating source, e.g., a candle, STERNO® fuel or alcohol burner, is used to warm or heat the water in the double-boiler pan which, in turn, heats, by convection, the prepared foods.

Depending on the size of the chafing dish assembly, up to three fuel containers may be required to adequately warm or heat the prepared food in a serving dish or chafing dish.

Also, in certain food serving applications, e.g. soups, meat or the like being the prepared foods, the chafing dish assemblies may comprise a chafing dish support structure for holding a serving dish or chafing dish thereby eliminating the use of a double-boiler pan or warming pan. A chafing dish cover or lid may be used to cover the serving dish or chafing dish. Heat for a heating source, e.g., a candle, STERNO® fuel or alcohol burner, is used to directly warm or heat the prepared food in the serving dish or chafing dish.

In such food serving application where a heating source is used to indirectly, through use of a double-boiler pan or warming pan, or directly warm or heat the prepared food in the serving dish or chafing dish, the heating burner subassembly may required to provide a variable volume of heat from the heating source to a desired portion of a warming pan, serving dish or chafing dish. The heating burner subassembly of the present invention provides the ability to provide such variable volume of heat.

Certain of the food serving applications are provided in environments where the ornamental value or appearance of the chafing dish assemblies at a function becomes important. Food serving firms, catering services, food and beverage operations and departments, hotels and the like can use the present invention in the form of a chafing dish serving station to enhance the visual appearance of the chafing dish assemblies being used for the food dispensing and for providing a theme, logo, message, graphic indicia and the like in association with the food services or function where the food is being dispensed.

The chafing dish support structure of the present invention can be used as a stand alone serving station using the heating burner subassembly, or as a component of the chafing dish serving station having decorative shell rigid exterior wall members fabricated from a material which is fire resistant so as enclose a heating burner and having one of its spaced opposed outer walls positioned away from the chafing dish support structure to define a viewing surface having an exterior outer surface fabricated with a material depicting an ornamental appearance forming a chafing dish serving station having an appearance defined by the viewing surface ornamental appearance.

### Chafing Dish Support Structure and Chafing Dish Serving Station

In the description of the invention set forth herein, common elements in the various views of the figures are identified by the same element number.

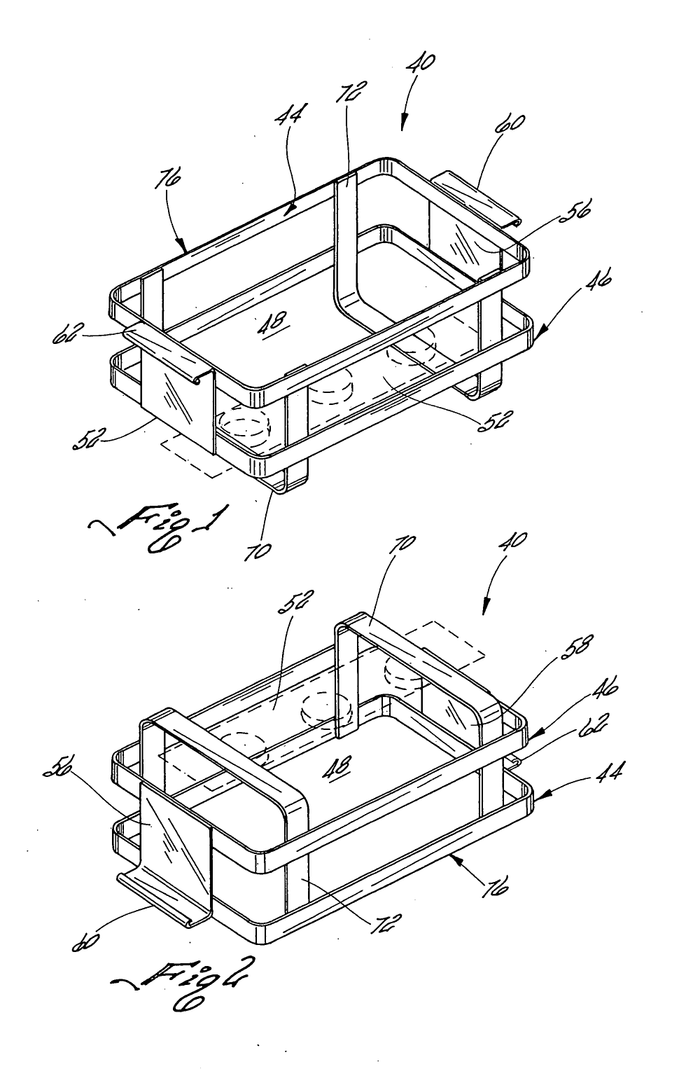

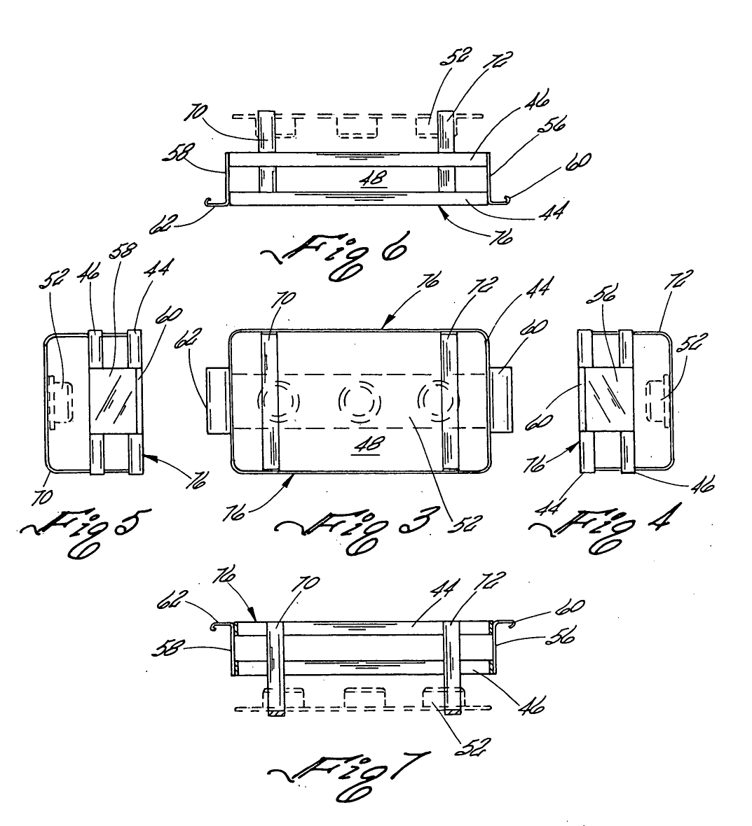

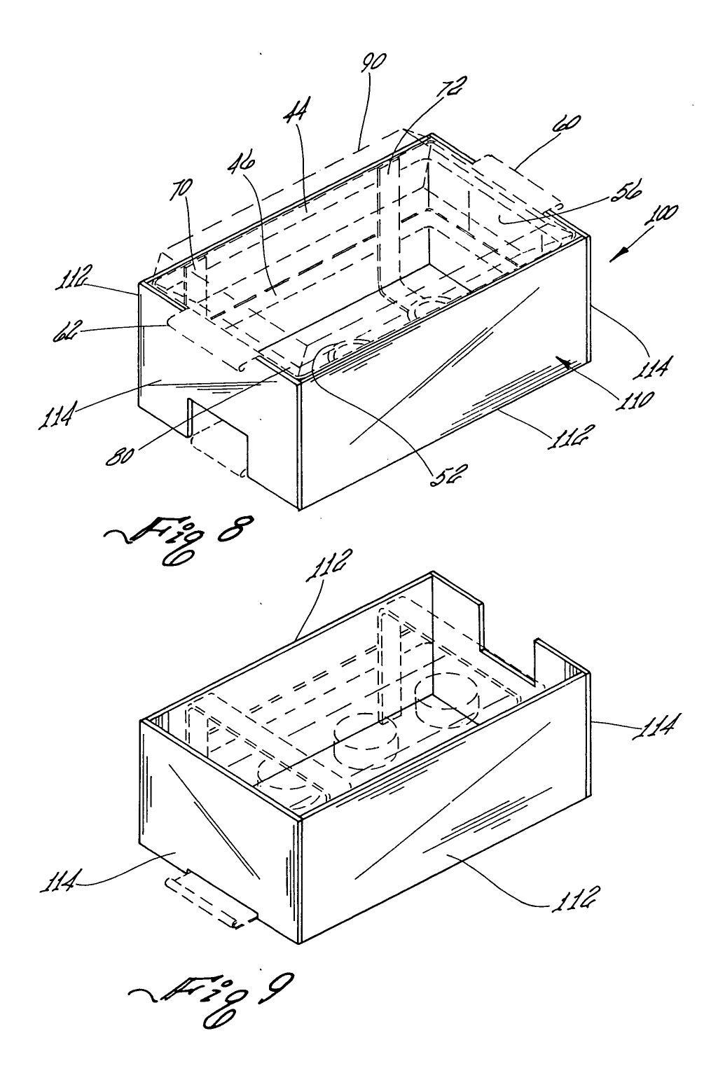

FIGS. 1 through 7 disclose a preferred embodiment of a chafing dish support structure shown by arrow 40 of the present invention.

In FIGS. 1 and 2, the chafing dish support structure 40 comprises a pair of spaced, co-planar elongated sidewall defining members 44 and 46 having a selected longitudinal dimension and a selected lateral dimension. The shaped of the preferred embodiment is generally rectangular shape. However, it is envisioned that the chafing dish support structure 40 can be fabricated into a desired shape including, without limitation, square shaped, oblong shaped, oval shaped, circular shaped, triangular shape or any other geometrical shape. FIGS. 34, 35 and 36, which illustrate a square, oval and circular shape respectively, are discusses hereinafter.

Sidewall defining members 44 and 46 are configured for forming a chafing dish receiving section, designated generally as 48, for supporting at least one of a double-boiler heating pan or heating warming pan, collectively referred to hereinafter as a “warming pan”, and a serving dish or chafing dish, illustrated by dashed lines 80 in FIG. 8, above a heating burner, preferably a heating burner subassembly discussed hereinafter, shown by dashed lines 52 which is placed below the chafing dish. Each of the sidewall-defining members 44 and 46 are fixedly rigidly attached to opposed end structural members 56 and 58 that define lifting members 60 and 62 respectively. The shape of the chafing dish receiving section would be dictated or determined by the selected shape of the chafing dish support structure. Likewise, the shape of a warming pan, serving dish or chafing dish would be dictated by or determined the selected shape of the chafing dish support structure.

A pair of spaced, elongated, preferably but not necessarily co-planar, support members 70 and 72, defining horizontal and vertically extending support members, are operatively connected to each of the sidewall defining members 44 and 46 at predetermined locations for supporting the chafing dish receiving section 48 above a heating burner placed 52 below at least one of a chafing dish and warming pan positioned in the chafing dish receiving section 48.

In FIGS. 3 through 7, the chafing dish support structure 40 has a generally rectangular shape having a selected lateral width and a selected longitudinal width. The width is a function of the width of the double warming pan, serving dish or chafing dish to be supported thereby.

As illustrated in FIGS. 1 through 7, the chafing dish support structure 40-end structural members 56 and 58 defining the lifting members 60 and 62 can be characterized as generally planar shaped, vertically extending members having one end thereof terminating in an outwardly extending lip lifting member.

The chafing dish support structure 40 is configured to have each of the sidewall-defining members 44 and 46 positioned relative to each other to form an upper member and a spaced lower member with the spaced lower member positioned relative to the heating burner 52. The sidewall defining member upper member 44 has an outer circumferential edge shown generally by arrow 76 configured to cooperate with an outer edge of a chafing dish to support at least one of a chafing dish and warming pan in the chafing dish receiving section 48 above a heating burner 52.

In FIGS. 1 through 7, the chafing dish support structure 70 has a pair of spaced, co-planar elongated sidewall defining members 44 and 46 which are thin, spaced, co-planar elongated sidewall defining members having a generally rectangular cross-section. The thin, spaced, co-planar elongated sidewall-defining members are preferably of the same geometrical dimension. However, it is envisioned that the thin, spaced, co-planar elongated sidewall defining members generally rectangular cross-section may be fabricated of different geometrical dimensions.

In the preferred embodiment illustrated by FIGS. 1 through 7, the sidewall-defining members may be formed of 080 stainless steel having a width of about 1 inch and the thickness of about 0.080 inches. The pair of spaced, elongated co-planar support members 70 and 72 may be formed of 080 stainless steel having a width of about 2 inches and the thickness of about 0.080 inches. The opposed end structural members 56 and 58 which define lifting members 60 and 62 respectively may be formed of 060 stainless steel and have a thickness of about 0.060 inches. Of course, the entire chafing dish support structure could be fabricated to have the sidewall-defining members 44 and 46 and the pair of spaced, elongated, preferably but not necessarily, co-planar support members 70 and 72 formed of the same material, e.g. 080 stainless steel having a width of about 1 inch.

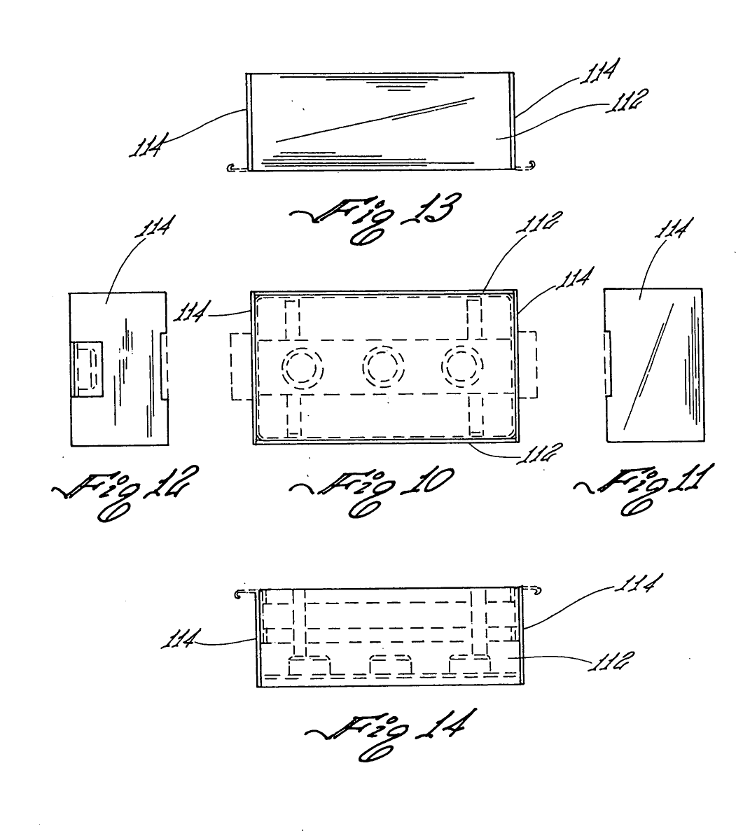

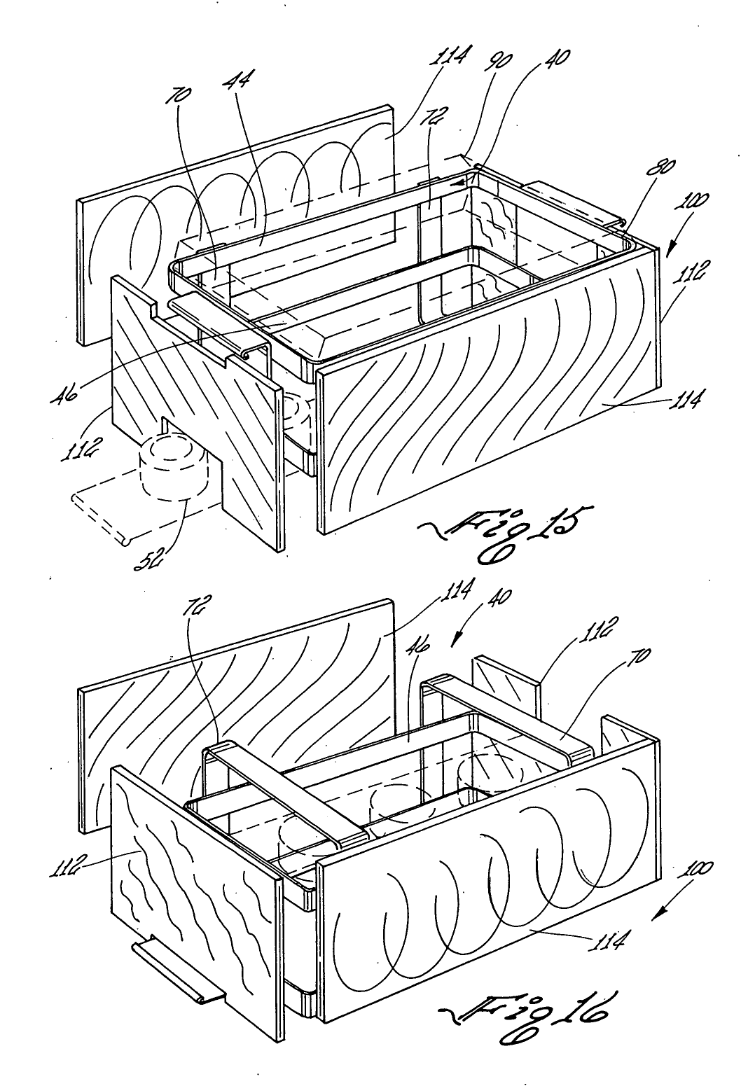

In FIGS. 8 through 15, a chafing dish serving station 100 is shown having, in phantom, the chafing dish support structure 40 of FIGS. 1 through 7 and the heating burner sub-assembly 52 with a chafing dish/warming pan 80 enclosed therein and chafing dish cover 90 also shown in phantom.

In its broadest aspect, the chafing dish serving station 100 comprises a chafing dish supporting structure which may be in the form of a prior art chafing dish structure, such as for example, the prior art chafing dish structure illustrated in FIG. 22, or the chafing dish support structure of the present invention shown by FIGS. 1 through 7. The chafing dish support structure enclosed by the chafing dish serving station 100 has a selected longitudinal dimension, a selected lateral dimension and selected vertical height and is configured in a selected shape for forming a chafing dish receiving section for supporting a chafing dish/warming pan 80 above a heating burner 52 placed below the chafing dish/warming pan 80. The chafing dish support structure has a selected vertical height and a selected lineal outer dimension that entirely circumscribes the selected longitudinal dimension and selected lateral dimension.

A decorative shell structure, shown generally by arrow 110, in the preferred embodiment has at least two pair of decorative shell rigid exterior wall members 112 and 114 having spaced opposed outer walls having a vertical height substantially equal to the selected vertical height of the chafing dish support and a selected lineal dimension so as to enclose the chafing dish support structure and heating burner. The two pair of decorative shell rigid exterior wall members 112 and 114 has a total lineal length substantially equal to that of the lineal outer dimension of the chafing dish support structure.

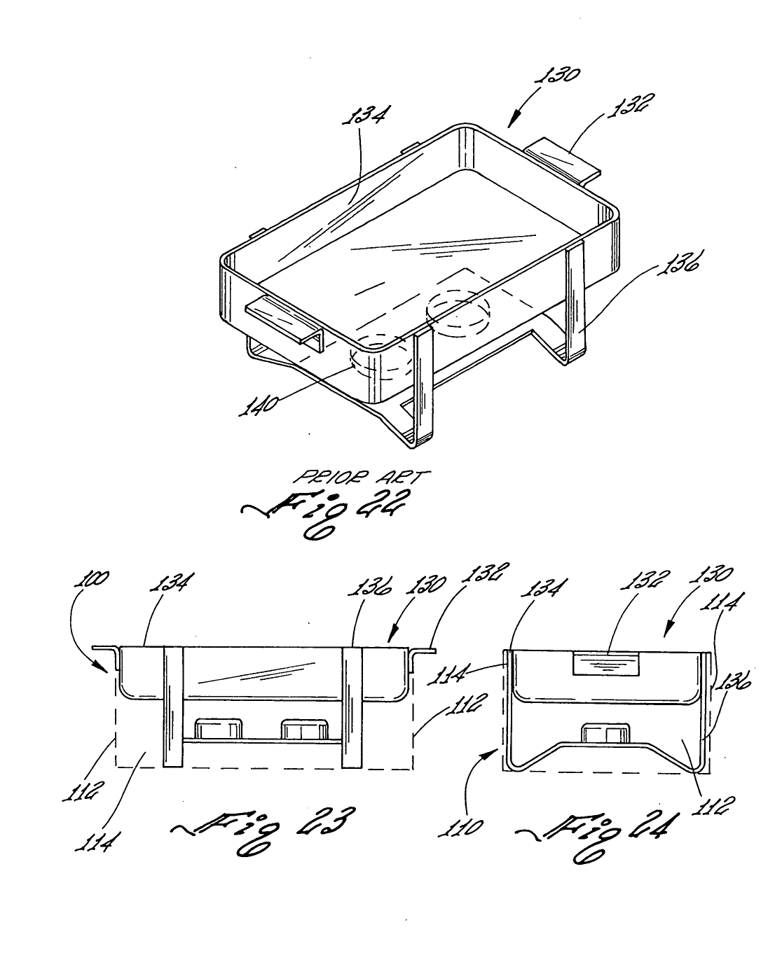

FIGS. 16 through 21 illustrate the preferred embodiment of the present invention comprising a chafing dish support structure 40 illustrated in FIGS. 1 through 7 and the chafing dish serving station 100 of FIGS. 8 through 14.

FIGS. 16 and 17 are exploded perspective views of the combination of the chafing dish support structure 40 and the chafing dish serving station 100 and illustrate the positional relationship of the decorative shell structure comprising the decorative shell rigid exterior wall members 112 and 114 relative to the chafing dish support structure.

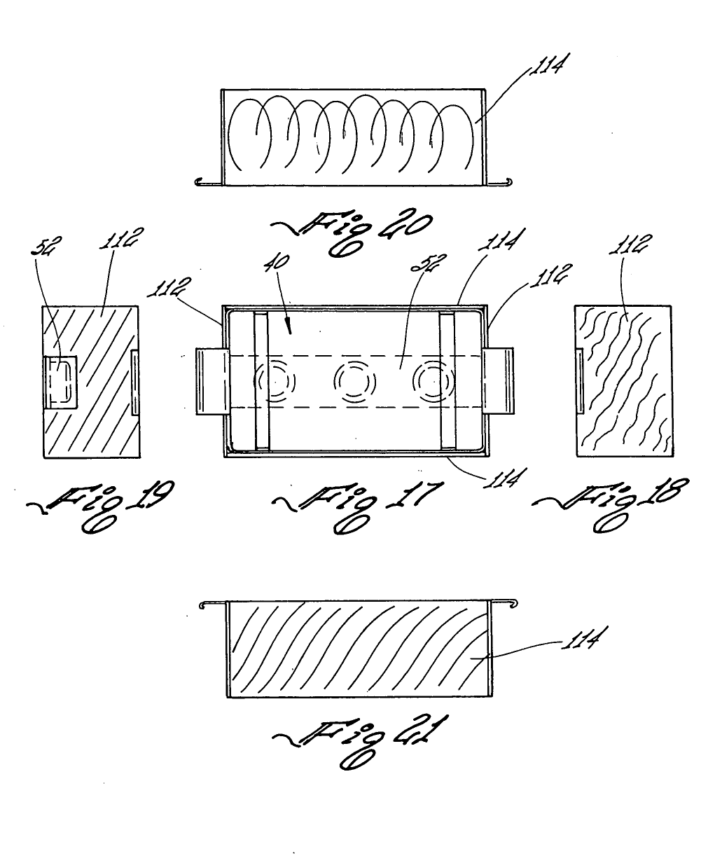

FIGS. 18 through 22 illustrate the decorative shell rigid exterior wall members 112 and 114 being removeably attached to the chafing dish support structure 40. The decorative shell rigid exterior wall members 112 and 114 are fabricated from a material that have appropriate physical characteristics including being fire resistant so as enclose a heating burner.

As illustrated in FIGS. 15 through 21, the decorative shell structure rigid exterior wall members 112 and 114 have one of the spaced opposed outer wall positioned away from the chafing dish support structure 40 to define a viewing surface. The viewing surface has an exterior outer surface fabricated with a material depicting an ornamental appearance forming a chafing dish serving station having an appearance defined by the viewing surface ornamental appearance.

As set forth above, the chafing dish serving station 100 can be used with a prior art chafing dish support structure. FIG. 22 illustrates a perspective view of a typical prior art chafing dish support structure shown generally as 130. The typical prior art chafing dish support structure 130 has at least one sidewall-defining member 134 having a longitudinal length and a lateral width supported by leg members 136. The typical prior art chafing dish support structure configured for forming a chafing dish receiving section 138, generally rectangular shaped, for supporting at least one of a chafing dish and warming pan above a heating burner 140 placed below the chafing dish receiving section 138. Handles 132 are used for lifting the chafing dish support structure 130.

FIGS. 23 and 23 are a front elevational view and a right side elevational view, respectively, of the chafing dish support structure 130 of FIG. 22 in combination with a chafing dish serving station 100 having the decorative shell structure shown in dashed lines. The chafing dish serving station 100 is configured to be removeably attached to the chafing dish support structure 130 exposing the viewing surface of the chafing dish serving station 100 forming a chafing dish serving station having an appearance defined by the viewing surface ornamental appearance.

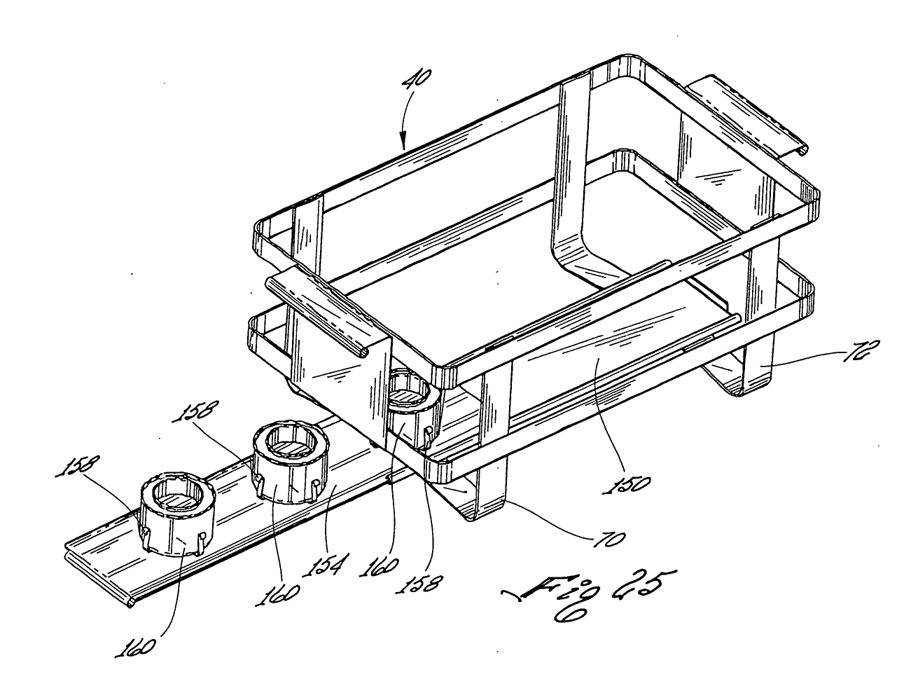

In the perspective view of FIG. 25, the chafing dish support structure 40 shown in FIGS. 1 through 7 is depicted to have a heating burner subassembly 52 located below the chafing dish receiving section 48. The heating burner subassembly 52 has a fixed base support member 150 which is rigidly attached in a substantially horizontal position to the pair of spaced, elongated co-planar support members 70 and 72. An insertable and removable slidable support member 154 may have one or more heating burner clamping sections 158 configured for removeably holding heating fuel burning containers 160 in position thereon.

The insertable and removable slidable support member 154 having one or more heating burner clamping sections 158 is slidable with in the fixed base support member 150 between an extended loading position and a inserted heating position. The insertable and removable slidable support member 154 is illustrated as having three fuel burner containers 160. However, alternatively, one, two or three fuel burner containers 160 may be used depending upon the amount of heating desired. In FIG. 25, the insertable and removable slideable support member 154 is shown in the extended loading position.

FIG. 26 is an exploded pictorial representation of the insertable and removable slidable support member 154 having one or more heating burner clamping sections 158. Each heating burner clamping sections 158 has a burner base 162 and a plurality of secured positioning members or resilient clamping members 164 extending from the burner base 162 for removably holding heating burner fuel containers 160 in position thereon.

FIG. 27 is an exploded pictorial representation of a decorative shell rigid exterior wall member 200 having a substrate 202 having spaced opposed outer walls 210 and 212 having a vertical height substantially equal to the vertical height of a chafing dish support structure and configured as a side wall to form a chafing dish serving station 100.

The substrate 202 is fabricated to have a first surface and a second surface defining the spaced opposed outer walls 210 and 212. The substrate is formed of a material that is configured to optimize strength to function as a rigid exterior wall member and having a selected coefficient of thermal expansion to maintain its strength when exposed to heat from a heating burner, e.g., heating burner subassembly 52. The substrate 202 has formed thereon a thin coating of a finishing material applied to one of the pair of opposed surfaces, e.g. opposed outer wall 210, in the form of a thin coating forming an exterior outer surface having a fabricated ornamental appearance.

The preferred properties and technical characteristics of the decorative shell rigid exterior wall members 112 and 114 are as follows:

| Property | Technical Characteristics |
|---|---|
| Density | About 27 lbs/cu ft to about |
| | 30 lbs/cu ft |
| | (0.43 g/cc-0.48 g/cc) |
| Crush Strength | >1500 psi |
| Flex Strength | >250 psi |
| Coefficient of thermal expansion | About 6 ppm/inch/degree to about |
| (CTE) | 7 ppm/inch/degreeF. |
| Thermal K | 0.1 Watt/meter/K |
| Thermal Gradient (Tg) | >250 F. |

An example of another decorative panel that could be used in practicing this invention is disclosed in U.S. Pat. No. 5,861,639.

A thin sheet member 220 having a first surface and a second surface 226 and 228, is used as a supporting member for mounting the substrate 200 to the chafing dish support structure. The first surface 226 is to be positioned contiguous the chafing dish support structure. The second surface 228 is to be rigidly attached to the opposed outer wall 212 with an appropriate adhesive, e.g. a heat resistant epoxy. The first surface 226 has an elongated slotted circumferential edge support 232 formed thereon which is configured to be removable attached to the circumferential edge 76, shown in FIG. 1, for supporting the exterior outer surface 210 having a fabricated ornamental appearance thereon in a vertical orientation on the chafing dish support structure 40. With the decorative shell rigid exterior wall member removeably attach in a substantially vertical position on said chafing dish support structure, a chafing dish serving station 100 is formed having an appearance defined by said fabricated ornamental appearance.

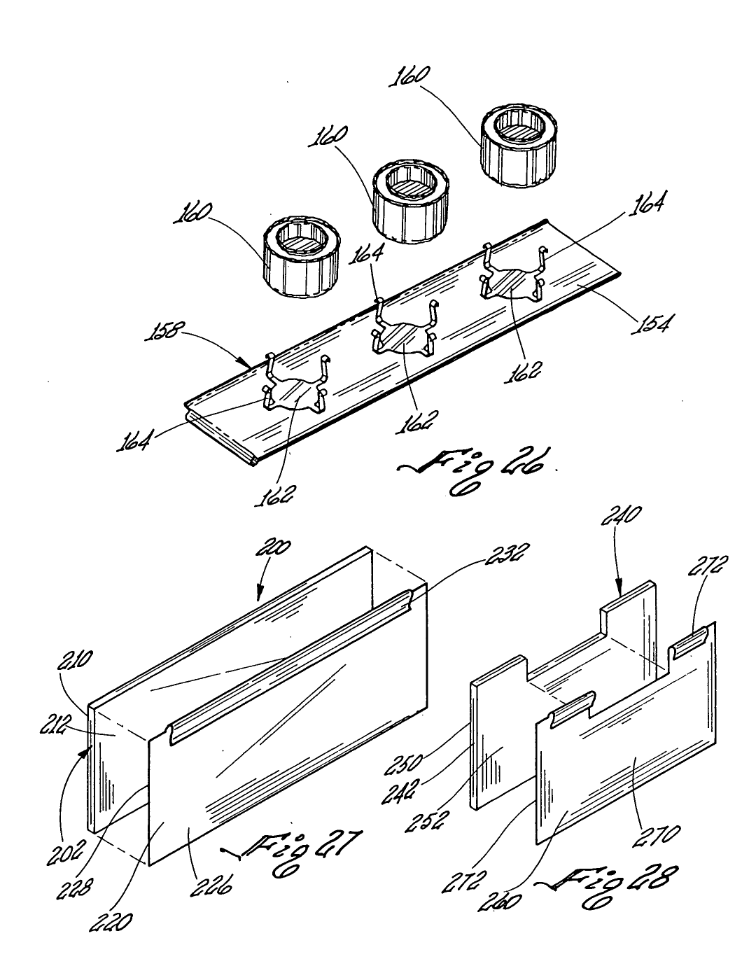

FIG. 28 is an exploded pictorial representation of a decorative shell rigid exterior wall member 240 having spaced opposed outer walls having a vertical height substantially equal to the vertical height of a chafing dish support structure and configured as an end wall to form a chafing dish serving station 100. The decorative shell rigid exterior wall member 240 has a substrate 242 having spaced opposed outer walls 250 and 252 having a vertical height substantially equal to the vertical height of a chafing dish support structure and configured as a sidewall to form a chafing dish serving station 100.

The substrate 242 is fabricated has a first surface and a second surface defining the spaced opposed outer walls 250 and 252. The substrate 242 is formed of a material that is configured to optimize strength so to function as a rigid exterior wall member having a selected coefficient of thermal expansion to maintain the strength when exposed to heat from a heating burner, e.g., heating burner subassembly 52.

The substrate 242 has formed thereon has a thin coating of a finishing material applied to one of the pair of opposed surfaces, e.g. opposed outer wall 250, in the form of a thin coating forming an exterior outer surface having a fabricated ornamental appearance.

A thin sheet member 260 having a first surface and a second surface 270 and 272, respectively, used as a supporting member for mounting the substrate 242 to the chafing dish support structure. The first surface 270 is to be positioned contiguous the chafing dish support structure. The second surface 272 is to be rigidly attached to the opposed outer wall 252 with an appropriate adhesive, e.g. a heat resistant epoxy. The first surface 270 has an elongated slotted circumferential edge support 272 formed thereon which is configured to be removable attached to the circumferential edge 76, shown in FIG. 1, for supporting the exterior outer surface 201 having a fabricated ornamental appearance thereon in a vertical orientation on the chafing dish support structure 40. With the decorative shell rigid exterior wall member removeably attach in a substantially vertical position on said chafing dish support structure, a chafing dish serving station 100 is formed having an appearance defined by said fabricated ornamental appearance.

In FIG. 28, the assembled decorative shell rigid exterior wall member 240 has a notch formed in the top surface thereof to facilitate the passage of the lifting members 60 and 62.

Of course, an assembled decorative shell rigid exterior wall member as illustrated in FIG. 8 for facilitating use of the insertable and removable member of the heating burner subassembly 52, would have an appropriate opening formed in the bottom section thereof.

In the exploded pictorial representation of FIG. 29 showing a combination of a chafing dish support structure 40 of FIG. 1, two pair of decorative shell rigid exterior wall members having spaced opposed outer walls having a vertical height substantially equal to the vertical height of a chafing dish support structure. The decorative shell rigid exterior wall members are shown using the structure for the side wall and end walls as depicted in FIGS. 27 and 28 and are configured to form a chafing dish serving station incorporating the chafing dish support structure 40 and a heating burner subassembly 40.

The pictorial representations of FIGS. 30A and 30B show an end structural member 56 defining a lifting member 62 in the form of a shaped, planar structural member having an outwardly extending top member defining a lifting lip 300. A thermally insulated lifting member 302 having a hollowed out central area 306 is configured to removeably slide onto and enclose the lifting lip 300.

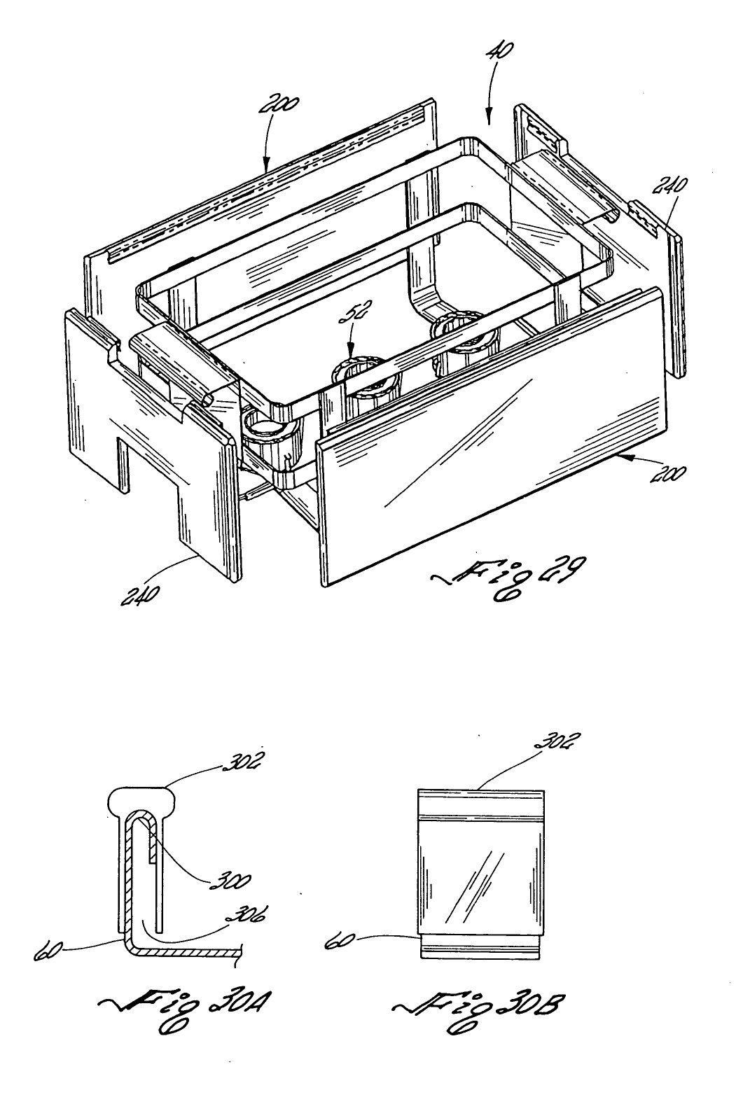

The elevational view pictorial representation of FIG. 31 is of a decorative shell rigid exterior wall member similar to that of FIG. 27 having substrate 202 having a viewing surface on an exterior outer surface fabricated with a material depicting an ornamental appearance configured to be removeably attached to a chafing dish support structure by an attachment member in the form of support plate 220 an elongated groove 232 to form a chafing dish serving station 100 having an appearance defined by the viewing surface ornamental appearance.

FIGS. 32A and 32B are pictorial representations of another structure for attaching the decorative shell rigid exterior wall member to a chafing dish support structure. A section of a decorative shell rigid exterior wall member 200, having spaced opposed outer walls and a viewing surface having an exterior outer surface fabricated with a material depicting an ornamental appearance configured to be removeably attached to a chafing dish support structure, has an attachment cooperating member in the form of an aperture 320 for supportingly engaging a hook-like member 330 located on a chafing dish support structure 40 for removeably attaching the decorative shell rigid outer member to a hook-like member 330 to form a chafing dish serving station having an appearance defined by said viewing surface ornamental appearance.

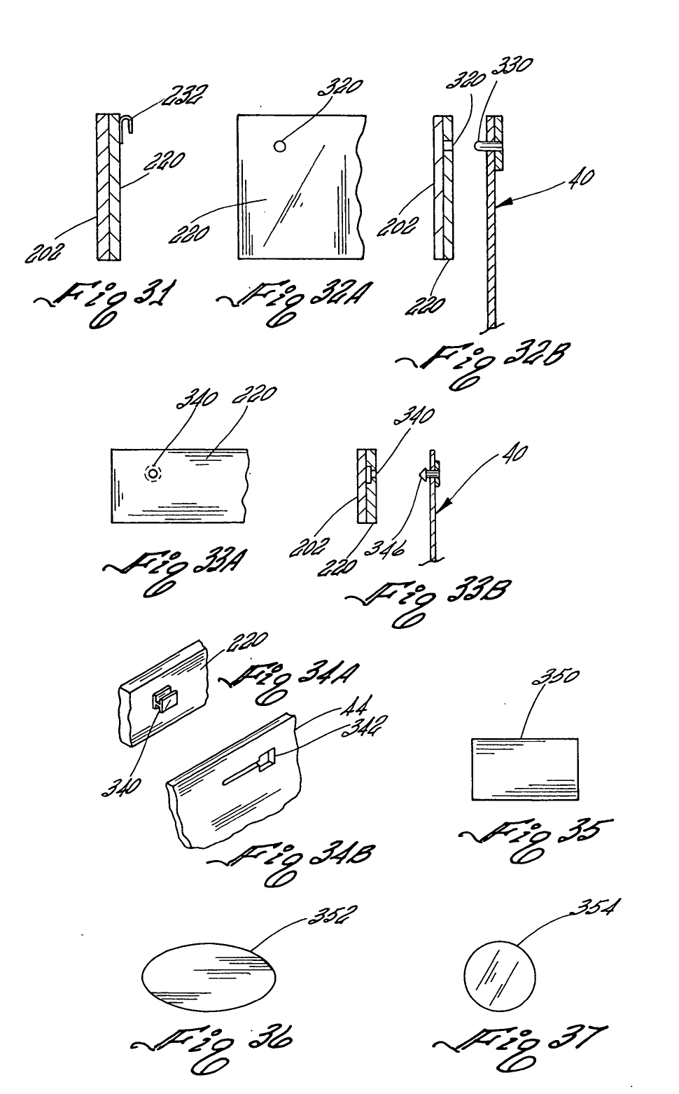

FIGS. 33A and 33B are pictorial representations of another structure for attaching the decorative shell rigid exterior wall member to a chafing dish support structure.

A section of a decorative shell rigid exterior wall member 200, having spaced opposed outer walls and a viewing surface having an exterior outer surface fabricated with a material depicting an ornamental appearance configured to be removeably attached to a chafing dish support structure, has an attachment member in the form of a female fastening member 340 for supportingly engaging a conical-shaped male fastening member 346 located on a chafing dish support structure 40 for removeably attaching, with a “snap” action, the decorative shell rigid outer member to a protruding conical-shaped male fastening member 346 to form a chafing dish serving station having an appearance defined by said viewing surface ornamental appearance.

It is envisioned that the shape of a chafing dish support structure and/or a chafing dish serving station can be of any shape including a mobeous shape and a geometrical shape. The chafing dish/warming pan to be received and supported in a chafing dish receiving section would, of necessity, need to be fabricated in the desired shape.

Examples of popular geometrical shapes are shown by FIG. 34 through 36. FIG. 34 shows a pictorial representation of a chafing dish support structure having a geometrical shape which is a generally rectangular shape depicted by solid line 350. FIG. 35 shows a pictorial representation of a chafing dish support structure having a geometrical shape that is generally an oval shape depicted by solid line 352. FIG. 36 shows a pictorial representation of a chafing dish support structure having a geometrical shape that is generally circular shape depicted by solid line 354.

It is also envisioned that graphic images, pictures, logos, trademarks, service marks, trade names, individual or firm names, monograms, slogans, letters and the like can be affixed to or applied to the exterior surface of the chafing dish serving station forming the viewing surface to project an desire appearance. Also, the viewing surface can be formed of a selected finish such as marble, granite, slate, faux finish, colored finish, painted finish or any variation thereof or the like to project a theme, e.g., a waterfall picture surface for a Hawaiian theme.

The decorative shell rigid exterior wall member coating layer defining an exterior outer surface having an ornamental appearance maybe fabricated as a protective, outer layer providing protection from environmental conditions.

It is further envisioned that the chafing dish support structure, chafing dish serving station or combination thereof in substantially the preferred embodiment or a variation thereof may have utility as a buffet serving station or the like. It will be appreciated that various alterations and modifications may be made to the chafing dish support structure, chafing dish serving station or combination thereof to enhance the functional characteristics thereof. All such variations and modifications should be considered to fall within the scope of the invention as broadly hereinbefore described and as claimed hereafter.

All such uses, variations, modifications and the like are anticipated to be within the scope of this invention.

1. A chafing dish support structure comprising:
a pair of spaced, elongated sidewall defining members having a selected longitudinal dimension and a selected lateral dimension configured for forming a chafing dish receiving section for supporting at least one of a chafing dish and a warming pan above a heating burner placed below the chafing dish receiving section, each of said sidewall defining members having opposed end structural members defining lifting members; and
a pair of spaced, elongated support members defining horizontal and vertically extending support members operatively connected to each of the sidewall defining members at predetermined locations for supporting said chafing dish receiving section above a heating burner placed below the chafing dish receiving section.

2. The chafing dish support structure of claim 1 wherein said pair of spaced, elongated sidewall defining members is in the form of a geometrical shape.

3. The chafing dish support structure of claim 2 wherein the geometrical shape is a generally rectangular shape.

4. The chafing dish support structure of claim 2 wherein said pair of spaced, elongated sidewall defining members have a selected longitudinal dimension and a selected lateral dimension configured for forming a generally rectangular shaped chafing dish receiving section.

5. The chafing dish support structure of claim 2 wherein the geometrical shape is a generally oval shape.

6. The chafing dish support structure of claim 2 wherein the geometrical shape is a generally circular shape.

7. The chafing dish support structure of claim 2 wherein the geometrical shape is a generally square shape.

8. The chafing dish support structure of claim 1 wherein said selected longitudinal dimension is a selected longitudinal length.

9. The chafing dish support structure of claim 1 wherein said selected lateral dimension is a selected longitudinal length.

10. The chafing dish support structure of claim 1 wherein said end structural members defining lifting members are generally planar shaped, vertically extending members having one end thereof terminating in an outwardly extending lifting member.

11. The chafing dish support structure of claim 1 wherein each of said sidewall defining members are positioned relative to each other to form an upper member and a spaced lower member with the spaced lower member positioned relative to the heating burner and wherein the sidewall defining members upper member has an outer circumferential edge configured to cooperate with an outer edge of at least one of chafing dish and a warming pan to support at least one of chafing dish and a warming pan in the chafing dish receiving section above a heating burner.

12. The chafing dish support structure of claim 1 wherein each of said pair of spaced, elongated sidewall defining members is thin, spaced, co-planar elongated sidewall defining members having a generally rectangular cross-section.

13. The chafing dish support structure of claim 12 wherein each of said pair of thin, spaced, co-planar elongated sidewall defining members has a generally rectangular cross-section that is of the same geometrical dimension.

14. The chafing dish support structure of claim 12 wherein each of said pair of thin, spaced, co-planar elongated sidewall defining members has a generally rectangular cross-section, which are of different geometrical dimensions.

15. The chafing dish support structure of claim 1 wherein said pair of spaced, elongated sidewall defining members and said pair of spaced, elongated support members defining the horizontal and vertically extending support members are fabricated from stainless steel.

16. The chafing dish support structure of claim 15 wherein said stainless steel is 080 stainless steel.

17. The chafing dish support structure of claim 15 wherein said stainless steel is 060 stainless steel.

18. The chafing dish support structure of claim 1 wherein each of said sidewall defining members having opposed end structural members defining lifting members are in the form of a shaped, planar structural member having an outwardly extending top member defining a lifting lip.

19. The chafing dish support structure of claim 18 further comprising
a thermally insulated lifting member having a hollowed out central area configured to removeably slide onto and enclose said lifting lip.

20. The chafing dish support structure of claim 1 wherein said heating burner is a heating burner subassembly.

21. A chafing dish serving station comprising:
a chafing dish supporting structure having a selected longitudinal dimension and a selected lateral dimension configured for forming a chafing dish receiving section for supporting at least one of a chafing dish and a warming pan above a heating burner placed below the chafing dish receiving section, said chafing dish support structure having a selected vertical height and a selected lineal outer dimension which entirely circumscribes said selected longitudinal dimension and selected lateral dimension; and
a decorative shell structure having spaced opposed outer walls having a vertical height substantially equal to said selected vertical height and a lineal dimension substantially equal to selected lineal outer dimension so as to enclose said chafing dish structure and heating burner, said decorative shell structure being fabricated from a material which is fire resistant so as enclose a heater burner, said decorative shell structure having one of said spaced opposed outer wall positioned away from said chafing dish support structure to define a viewing surface having an exterior outer surface fabricated with a material depicting an ornamental appearance, said decorative shell structure being configured to be removeably attached to said chafing dish structure exposing said viewing surface forming a chafing dish serving station having an appearance defined by said viewing surface ornamental appearance.

22. The chafing dish serving station of claim 21 wherein said chafing dish support structure comprises
at least one sidewall defining member having a selected longitudinal dimension, a selected lateral dimension and a selected vertical height configured for forming a chafing dish receiving section for supporting at least one of a chafing dish and warming pan above a heating burner placed below the chafing dish support section, said sidewall defining members having opposed, shaped, end structural members defining lifting members;
elongated support members defining horizontal and vertically extending support members operatively connected to said sidewall defining members at predetermined locations for supporting said chafing dish receiving section above a heating burner placed below a chafing dish; and
wherein said decorative shell structure comprises a pair of spaced opposed outer side walls having a vertical height substantially equal to said selected vertical height and a pair of spaced opposed outer end walls having a vertical height substantially equal to said selected vertical height, said pair of side walls and said pair of end walls being removeably attached to and enclosing said chafing dish support structure including at least one of a chafing dish and warming pan supported in said chafing dish receiving section, said outer side walls and said outer end walls having a aggregate lineal dimension substantially equal to a lineal outer dimension of said chafing dish support structure for enclosing said chafing dish support structure and heating burner forming a chafing dish serving station having an appearance defined by said viewing surface ornamental appearance.

23. The chafing dish serving station of claim 21 wherein said chafing dish support structure comprises
a pair of spaced, co-planar elongated sidewall defining members having a selected longitudinal dimension and a selected lateral dimension configured for forming a chafing dish receiving section for supporting at least one of a chafing dish and warming pan above a heating burner placed below the chafing dish receiving section, each of said pair of said sidewall defining members having opposed, planar end structural members defining lifting members; and
a pair of spaced, elongated support members defining horizontal and vertically extending support members operatively connected to each of the sidewall defining members at predetermined locations for supporting said chafing dish receiving section above a heating burner placed below the chafing dish receiving section; and
wherein said decorative shell structure comprises a pair of spaced opposed outer side walls having a vertical height substantially equal to said selected vertical height and a pair of spaced opposed outer end walls having a vertical height substantially equal to said selected vertical height, said pair of side walls and said pair of end walls being removeably attached to and enclosing said chafing dish support structure including at least one of a chafing dish and warming pan supported therein in said chafing dish receiving section, said outer side walls and said outer end walls having a aggregate lineal dimension substantially equal to and so as to enclose said chafing dish support structure and heating burner forming a chafing dish serving station having an appearance defined by said viewing surface ornamental appearance.

24. The chafing dish serving station of claim 23 wherein said chafing dish support structure comprises
at least two sidewall defining member having a selected longitudinal length and a selected lateral length configured for forming a chafing dish receiving section for supporting at least one of a chafing dish and warming pan above a heating burner placed below the chafing dish receiving section, each of said sidewall defining members having opposed, shaped, end structural members defining lifting members.

25. The chafing dish serving station of claim 23 wherein said viewing surface has an exterior outer surface fabricated with a material depicting an ornamental granite surface.

26. The chafing dish serving station of claim 23 wherein said viewing surface has an exterior outer surface fabricated with a material depicting an ornamental marble surface.

27. The chafing dish serving station of claim 23 wherein said viewing surface has an exterior outer surface fabricated with a material depicting an ornamental faux surface.

28. A decorative shell structure configured to be removeably attached to a chafing dish supporting structure having a selected vertical height, a selected longitudinal length and a selected lateral length forming a chafing dish receiving section for supporting at least one of a chafing dish and warming pan above a heating burner placed below the chafing dish receiving section to form a chafing dish serving station, said decorative shell comprising:
at least one decorative shell rigid exterior wall member having spaced opposed outer walls having a vertical height substantially equal to said selected vertical height and a selected lineal dimension so as to enclose said chafing dish support structure and heating burner, said decorative shell being fabricated from a material which is fire resistant so as enclose a heater burner, said decorative shell structure having one of said spaced opposed outer walls positioned away from said chafing dish support structure to define a viewing surface having an exterior outer surface fabricated with a material depicting an ornamental appearance forming a chafing dish serving station having an appearance defined by said viewing surface ornamental appearance.

29. A decorative shell structure of claim 28 further comprising
at least two pair of decorative shell rigid exterior wall members having spaced opposed outer walls having a vertical height substantially equal to said selected vertical height and a selected lineal dimension so as to enclose said chafing dish support structure and heating burner, said at least two pair of decorative shell rigid exterior wall members having a total lineal length substantially equal to that of said selected lineal dimension.

30. The decorative shell structure of claim 28 wherein said at least one decorative shell rigid exterior wall member comprises
a substrate having a first surface and a second surface formed of a material that is configured to optimize strength to function as a rigid exterior wall member and having a selected coefficient of thermal expansion to maintain said strength when exposed to heat from a heater burner, said substrate having formed thereon a thin coating of a finishing material applied to one of the pair of opposed surfaces forming an exterior outer surface having a fabricated ornamental appearance; and
a thin sheet member having a first surface and a second surface, said first surface being attached to the other of the pair of opposed surfaces for supporting said an exterior outer surface having a fabricated ornamental appearance in a substantially vertical orientation, said second surface of the thin sheet member having a connecting member for removeably attaching said decorative shell rigid exterior wall member in a substantially vertical position on said chafing dish support structure to form a chafing dish serving station having an appearance defined by said fabricated ornamental appearance.

31. A heating burner subassembly comprising
a fixed base support member configured to be rigidly attached to a chafing dish support structure below a chafing dish receiving section; and
an insertable and removable slidable support member having a heating burner clamping section configured for removeably holding at least one heating burner fuel container in position thereon, said insertable and removable slideable support member having an extended loading position for loading at least one heating burner fuel container in said heating burner clamping section and an inserted heating position for positioning said at least one heating burner fuel container in said heating burner clamping section below a chafing dish receiving section to enable heating
thereof upon ignition of fuel in said at least one heating burner fuel container.

32. The heating burner subassembly of claim 31 wherein said insertable and removable slidable support member has a heating burner clamping section configured for removeably holding at least two heating burner fuel containers in position thereon.

33. The heating burner subassembly of claim 31 wherein said insertable and removable slidable support member has a heating burner clamping section configured for removeably holding at least three heating burner fuel containers in position thereon.

34. The heating burner subassembly of claim 31 wherein said heating burner clamping section is configured for resiliently removeably holding said at least one heating burner fuel container in said heating burner clamping section.

35. The heating burner subassembly of claim 31 wherein said heating burner clamping section comprises
a burner base having a plurality of secured positioning members extending from the burner base for removeably holding said at least one heating burner fuel container in position thereon.
